(19) United States
(12) Patent Application Publication
(10) Pub. No.: US 2019/0391462 A1
(43) Pub. Date: Dec. 26, 2019

(54) BLADE DRIVE DEVICE, AND IMAGE-CAPTURING EQUIPMENT, AND ACTUATOR WITH SAID BLADE DRIVE DEVICE

(71) Applicant: NIDEC COPAL CORPORATION, Tokyo (JP)

(72) Inventor: Ryosuke USHIO, Tokyo (JP)

(73) Assignee: NIDEC COPAL CORPORATION, Tokyo (JP)

(21) Appl. No.: 16/480,756

(22) PCT Filed: Jan. 10, 2018
(86) PCT No.: PCT/JP2018/000301

§ 371 Date: Jul. 25, 2019

(30) Foreign Application Priority Data
Jan. 25, 2017 (JP) 2017-011448

(51) Int. Cl. G03B 9/14

(52) U.S. Cl. CPC G03B 9/14

(57) ABSTRACT

The provision of: a base plate, having an opening for an optical path; a first blade and a second blade, for opening and closing an opening, through rotating along a blade supporting face that is present over the base plate; a magnet that is secured around the rotational center of the blade; a yoke that is secured to the base plate; and a coil that is wrapped on yoke, wherein: the yoke has an adjacent piece that is adjacent to the magnet, along the blade supporting face, and a cross piece along a side face portion of the base plate, extending in a direction that is perpendicular to the adjacent piece; and the coil is disposed on the cross piece side.

### CROSS REFERENCE TO RELATED APPLICATIONS

This is a U.S. National Phase Application under 35 U.S.C. § 371 of International Patent Application No. PCT/JP2018/000301, filed Jan. 10, 2018, which claims priority of Japanese Patent Application No. 2017-011448, filed Jan. 25, 2017. The entire contents of which are hereby incorporated by reference.

### FIELD OF TECHNOLOGY

The present invention relates to a blade driving device for opening and closing, through blades, an opening for an optical path, and to an image-capturing equipment and an actuator comprising this blade driving device.

### BACKGROUND

Conventionally, as this type of invention, there is been, as described in Japanese Unexamined Patent Application Publication 2012-78502, for example, a shutter mechanism for a camera, comprising: a base plate that has an opening portion for an optical path; a plurality of shutter blades for opening/closing the opening portion through each rotating at different positions over the base plate; and a driving source structured from a rotor, a coil, a yoke, and the like.

In this type of prior art, shutter blades for driving have been rotated by driving pins that are integrated with the rotor, to rotate other shutter blades, through driving linkage portions provided on these shutter blades for driving.

Given the prior art set forth in Japanese Unexamined Patent Application Publication 2012-78502, the rotational force of the rotor is relayed to a plurality of shutter blades through a plurality of driving pins and driving linkage portions, and thus the power relaying structure is complex. Moreover, the driving source is provided on one side of the base plate, and the shutter blades are provided on the other side, with the base plate therebetween, and thus there is a tendency for the structure to be thick in the direction of the axis of rotation.

Given this, while one may consider a structure wherein both the driving source and the shutter blade are disposed on one surface side of the base plate (substrate), as in the prior art taught in Japanese Unexamined Patent Application Publication 2006-189513, because all of the components are concentrated on one side of the base plate, there is a tendency for the device as a whole to be larger and thicker.

Moreover, in all of the prior art, when structuring through reducing the sizes of each of the components on the same side of the base plate, the magnet and the coil will also be smaller, preventing production of an adequate blade driving force. In particular, in an infrared radiation camera it is necessary to maintain the shutter blade in the opened state, but there is the danger that such a holding force cannot be produced.

### SUMMARY

In order to solve such a problem, the present invention is provided with the following structures:

A blade driving device, having a base plate, having an opening for an optical path; a blade for opening and closing an opening, through rotating along a blade supporting face that is present over the base plate; a magnet that is secured around the rotational center of the blade; a yoke that is secured to the base plate; and a coil that is wrapped on yoke, wherein: the yoke has an adjacent piece that is adjacent to the magnet, along the blade supporting face, and a cross piece along a side face portion of the base plate, extending in a direction that is perpendicular to the adjacent piece; and the coil is disposed on the cross piece side.

### BRIEF DESCRIPTIONS OF THE DRAWINGS

FIG. 1 depicts a first embodiment of a blade driving device according to the present invention, wherein FIG. 1a is an exterior perspective diagram viewed from the cover member side, and FIG. 1b is an exterior perspective diagram viewed from the base plate side (the incident light side).

FIG. 2 shows a perspective assembly view of an example.

FIG. 3 is a perspective diagram wherein critical portions of the example are viewed from the incident light side.

FIG. 4 is a perspective diagram depicting the assembly of critical portions of the example.

FIG. 5 is an exploded perspective diagram illustrating another example of a blade driving device according to the present invention.

FIG. 6 is a perspective diagram depicting a base plate in the other example.

FIG. 7 is a cross-sectional drawing along the section (VII)-(VII) of FIG. 6, showing the relationship between the base plate and the blade.

FIG. 8 is a perspective diagram depicting critical portions of the other example are viewed from the incident light side.

FIG. 9a and FIG. 9b are perspective diagrams depicting respective examples, in FIG. 9a and FIG. 9b, of image-capturing equipment.

FIG. 10 is a perspective diagram depicting an example of a mobile device.

### DETAILED DESCRIPTION

Examples according to the present invention will be explained below in reference to the drawings. In the descriptions below, identical reference symbols in the different drawings below indicate positions with identical functions, and redundant explanations in the various drawings are omitted as appropriate.

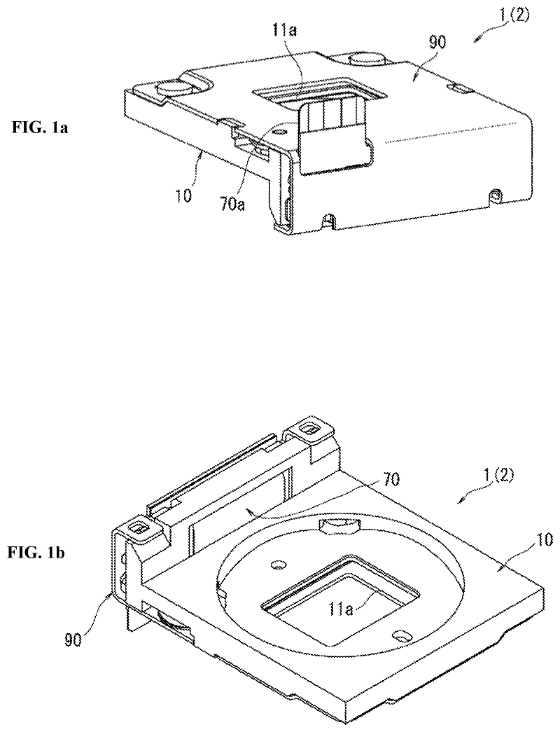

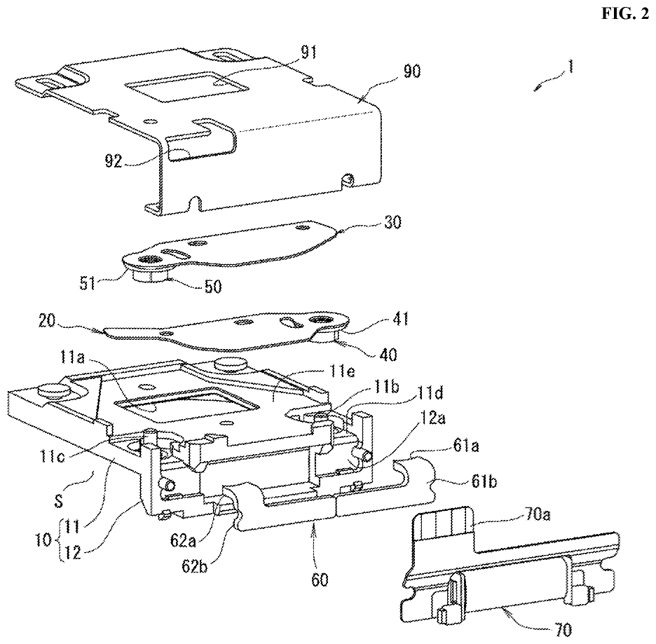

As illustrated in FIG. 1a, FIG. 1b and FIG. 2, this blade driving device 1 includes a base plate 10 having an opening 11a for an optical path; a first blade 20 and a second blade 30 for opening/closing the opening 11a through each rotating at different positions on a blade supporting face 11e of the base plate 10; a first magnet 40 that is secured around a rotary shaft of the first blade 20; a second magnet 50 that is secured around a rotary shaft of the second blade 30; a yoke 60 that is secured to the base plate 10; a coil 70 that is wound on the yoke 60; and a cover member 90.

The base plate 10 is formed in essentially a L-shape, when viewed from the side, and has a main unit portion 11 that has an opening 11a toward the center, and a supporting piece 12, for supporting the yoke 60, and the like, protruding in one optical axial direction, on one end side of the main unit portion 11. A space S on the incident light side of this base plate 10 is used for assembling a lens unit, and the like, not shown.

This base plate 10 is formed as a single unit from resin, or the like, through, for example, molding. However, as another example, it may instead be formed integrally through die casting aluminum or magnesium, or another metal material, an alloy thereof, or the like.

The main unit portion 11 is formed in a rectangular plate-shape, with a rectangular through hole-shape opening 11a toward the center of a blade supporting surface 11e thereof. The blade supporting face 11e is the bottom face of a recessed part that is formed on the surface on one side of the main unit portion 11, formed as a flat surface shape so that the first blade 20 and the second blade 30 will be rotated by a prescribed amount.

In the example of FIG. 2, the vertical direction in the figure, in the opening 11a, is the optical axial direction, formed so that light will be incident into the opening 11a.

Moreover, supporting shafts 11b and 11c are provided near, with a gap therefrom the supporting piece 12 on the surface of the main unit portion 11 that is in the direction opposite of the direction in which the supporting piece 12 protrudes. These supporting shafts 11b and 11c support, respectively, the first blade 20 and the second blade 30, described below, and protrude in the direction opposite that of the supporting piece 12.

The supporting shaft 11b and 11c is each a circular column-shaped shaft that protrudes perpendicularly in respect to the surface of the main unit portion 11. In one supporting shaft 11b, the outer peripheral surface makes sliding contact with the inner peripheral surface of the first magnet 40, to support the first magnet 40 so as to enable rotation. Similarly, with the other supporting shaft 11c, the outer peripheral surface thereof makes sliding contact with the inner peripheral surface of the second magnet 50, to support the second magnet 50 so as to enable rotation.

A recessed portion 11d, wherein the thickness of the main unit portion 11 has been made thinner, is provided around the supporting shafts 11b and 11c on the main unit portion 11, and the yoke 60 is fitted into the recessed portion 11d.

A fitting/supporting portion 12a of a recessed shape, into which the yoke 60, coil 70, and the like, are fitted and secured, is provided in a side face on the outside of the supporting piece 12.

Moreover, the first blade 20 and second blade 30 are each formed in a thin plate shape from, for example, an aluminum alloy, or the like, and open and close the opening 11a of the base plate 10 through rotating on the base plate 10.

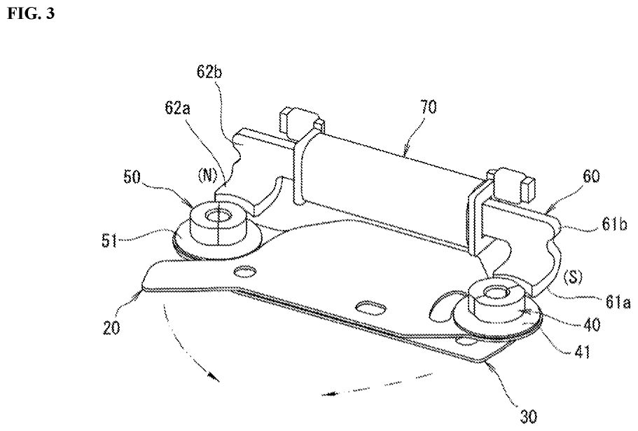

When opening or closing the opening 11a, the directions in which the first blade 20 and the second blade 30 rotate are mutually opposing directions of rotation, as illustrated in FIG. 3.

In the first blade 20, the first magnet 40 is secured around the axis of rotation, on the face that opposes the surface of the base plate 10, so as to rotate together therewith. Similarly, in the second blade 30 as well, the second magnet 50 is secured around the axis of rotation, on face that opposes the surface of the base plates 10, so as to rotate together therewith.

The first blade 20 and the second blade 30 overlap each other partially around the first magnet 40 and the second magnet 50. Specifically, the second blade 30 overlaps the first blade 20 on the opposing surface side of the base plate (the bottom side in FIG. 3).

The first magnet 40 and the second magnet 50 are each cylindrical permanent magnets that have mutually differing magnetic poles (north and south) on both sides in the radial direction, and are formed from a magnetic material such as, for example, samarium cobalt, ferrite, neodymium, or the like.

In the first magnet 40 one end portion in the axial direction is adhesively secured, through an adhesive agent 41, around the axis of rotation of the first blade 20, and the other end side is equipped in a ring shape so as to enable rotation in respect to the supporting shaft 11b of the base plate 10.

Similarly, in the second magnet 50, one end portion in the axial direction is adhesively secured, through an adhesive agent 51, around the axis of rotation of the second blade 30, and is equipped in a ring shape so as to enable rotation in respect to the supporting shaft 11c of the base plate 10.

The yoke 60 is structured from a magnetic material and has: a first adjacent piece 61a that is adjacent to the outer peripheral surface of the first magnet 40 from the outside in the radial direction along the blade supporting face 11e; a cross piece 61b along a side face portion of the base plate 10 (specifically, the supporting piece 12 surface), extending in a direction that crosses the first adjacent piece 61a; a second adjacent piece 62a that is adjacent to the outer peripheral surface of the second magnet 50 from the outside, in the radial direction, along the blade supporting face 11e; and a cross piece 62b along a side face portion of the base plate 10, provided extending in a direction that crosses the second adjacent piece 62a, wherein: a coil 70 is provided toward the center of the two cross pieces 61b and 62b.

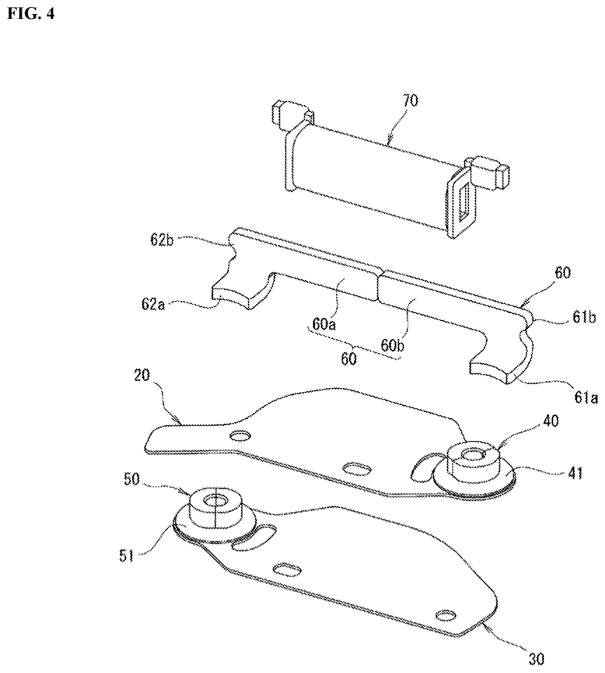

Note that with the yoke 60 according to the present embodiment, as a form that is particularly beneficial in terms of assemblability, one half portion 60b that has the first adjacent piece 61a and the cross piece 61b, and another half portion 60a that has the second adjacent piece 62a and the cross piece 62b, are connected at a center portion thereof into a single unit, as depicted in FIG. 4, but, as another example, these may be members that are processed in advance into a single unit.

The first adjacent piece 61a has an arc-shaped end face that is adjacent to the outer peripheral surface of the first magnet 40, with a prescribed clearance. Moreover, the crossing piece 61b is a position that is bent to essentially a right angle, in respect to the adjacent piece 61a, and fits together with the fitting/supporting portion 12a of the base plate 10.

Similarly, the second adjacent piece 62a has an arc-shaped end face that is adjacent to the outer peripheral surface of the second magnet 50, with a prescribed clearance. Moreover, the cross piece 62b is a position that is bent to essentially a right angle, in respect to the second adjacent piece 62a, and fits together with the fitting/supporting portion 12a of the base plate 10.

The two cross pieces 61b and 62b are lined up in a straight line, and are integrated into a single unit through contacting at the center side thereof.

The coil 70 is wound onto these two cross pieces 61b and 62b, so as to span the left and right cross pieces 61b and 62b.

The coil 70 is connected so as to produce one polarity (for example, north) at the first adjacent piece 61a side, and to produce the other polarity (for example, south) at the second adjacent piece 62a side, when electric power is supplied from the outside, to a power supply circuit, not illustrated, through a terminal plate 70a.

The cover member 90 is made from a hard material, such as, for example, a nonmagnetic stainless steel material, and is formed in a plate shape that has a cross-sectional L shape, covering, for example, the main unit portion 11 of the base plate 10 and the outer surface of the supporting piece 12 (referencing FIG. 1a, FIG. 1b and FIG. 2).

An opening 91, that communicates with the opening 11a of the base plate 10, is formed toward the center of the cover member 90.

The cover member 90 is connected securely to the base plate 10, so as to cover the first blade 20, the second blade 30, the first magnet 40, the second magnet 50, the yoke 60, the coil 70, the terminal plate 70a, and the like, described above, where the terminal part of the terminal plate 70a is inserted through the through hole 92 (referencing FIG. 2), to be exposed on the outside.

Given this, a photodetecting element, not shown (for example, a ferroelectric sensor, a thermopile, a bolometer, or another infrared radiation sensor, a CCD image sensor, a CMOS image sensor, or the like) is equipped so as to cover the opening 91 on the side of the cover member 90 that is opposite from the base plate side.

The operating effects that are the distinctive feature of the blade driving device 1 with the structure set forth above will be explained in detail next.

When DC electric power is supplied to the coil 70, then, at the one end side and the other end side of the coil 70, as illustrated in FIG. 3, different polarities (for example, north and south) will be produced at the first adjacent piece 61a and the second adjacent piece 62a, where the magnetism received by these adjacent pieces will cause the first magnet 40 and first blade 20, and the second magnet 50 and second blade 30, to each rotate in respective directions to open (or close) the opening 11a. Moreover, when the direction of the DC electric power is reversed, the first magnet 40 and first blade 20, and the second magnet 50 and second blade 30, will each rotate in the direction opposite of the direction described above.

In this way, because the magnet and blade, as a single unit, are rotated directly by the blade driving device 1, this enables smooth operation with good responsiveness, with little play, backlash, or the like, in the power transmission train, when compared to the prior art wherein the force from a single driving source is transmitted through linking pins, and the like, to a plurality of blades.

Moreover, because the first blade 20, the second blade 30, the first magnet 40, the second magnet 50, first adjacent piece 61a, second adjacent piece 62a, and the like, move along the surface on one side of the base plate 10, overall the structure is thin. In particular, in the present embodiment, the yoke 60 is fitted together with the part of the base plate 10 wherein one edge is bent to essentially a L-shape (specifically, the recessed portion 11d and the fitting/supporting portion 12a, and the like), to achieve a thin, compact structure.

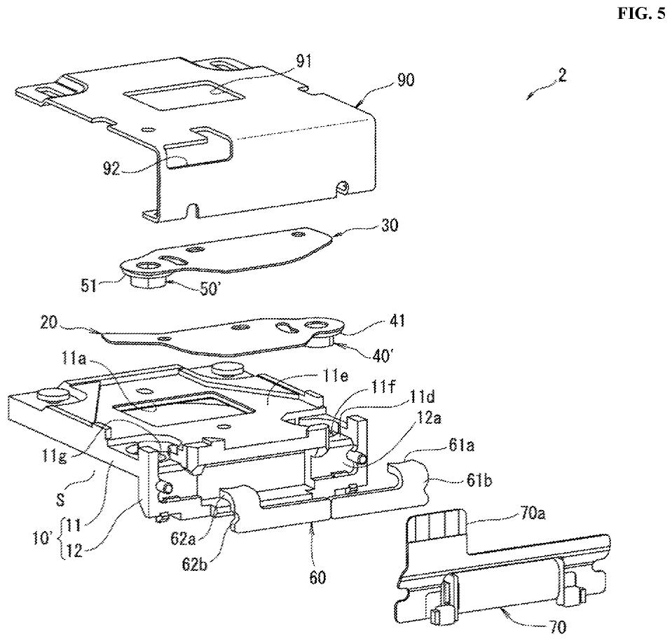

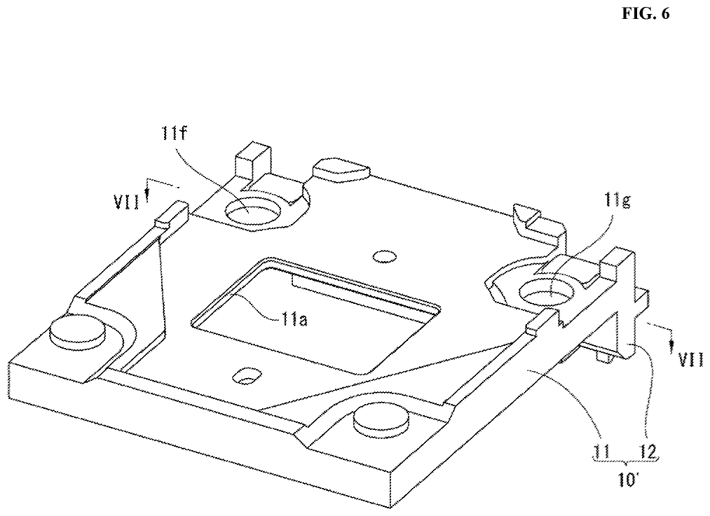

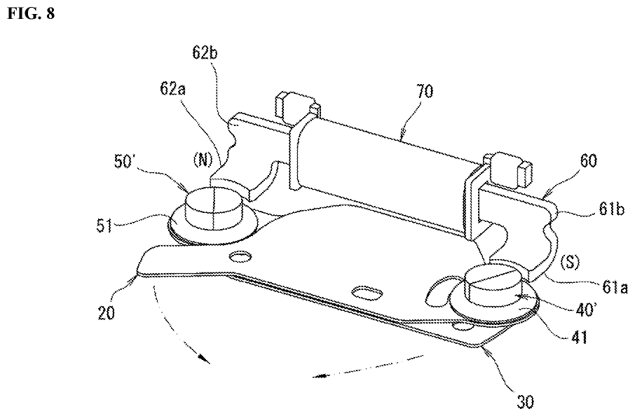

FIG. 5 through FIG. 8 depict a blade driving device 2 that is another example according to the present invention.

In this blade driving device 2, the base plate 10 of the blade driving device 1, described above, is replaced with a base plate 10′; the first magnet 40 is replaced with a first magnet 40′; and the second magnet 50 is replaced with a second magnet 50′; where the overall exterior shape is essentially identical to that of the blade driving device 1 (referencing FIG. 1a and FIG. 1b).

In the base plate 10′, the supporting shafts 11b and 11c of the base plate 10, described above, are replaced, respectively, with supporting recessed portions 11f and 11g.

As illustrated in FIG. 5 through FIG. 7, the supporting recessed portions 11f and 11g are formed in the shape of closed-bottom round cylindrical holes, provided at positions corresponding to the rotational center portions of the first blade 20 and the second blade 30, respectively.

The end portion side on the opposite side of the blade, of the first magnet 40′, is inserted into one supporting recessed portion 11f.

Similarly, the end portion side on the opposite side of the blade, of the second magnet 50′, is inserted into the other supporting recessed portion 11g.

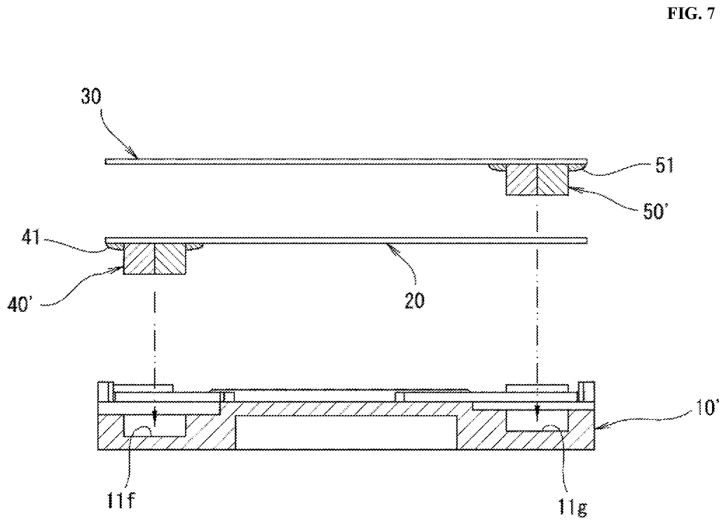

The first magnet 40′ is formed in a solid circular column shape having opposite polarities for one half portion and the other half portion, in the radial direction, where the first blade 20 is secured to one end side, in the axial direction, and the other end side is fitted into the supporting recessed portion 11f (referencing FIG. 7).

Given this, in this first magnet 40′, the outer peripheral surface on the side opposite from the blade is caused to make sliding contact on the inner peripheral surface of the supporting recessed portion 11f, and the end face thereof is contacted to the bottom of the supporting recessed portion 11f, and supported rotatably.

Similarly, the second magnet 50′ is formed in a solid circular column shape having opposite polarities for one half portion and the other half portion, in the radial direction, where the second blade 30 is secured to one end side, in the axial direction, and the other end side is fitted into the supporting recessed portion 11g (referencing FIG. 7).

Given this, in this second magnet 50′, the outer peripheral surface on the side opposite from the blade is caused to make sliding contact on the inner peripheral surface of the supporting recessed portion 11g, and the end face thereof is contacted to the bottom of the supporting recessed portion 11g, and supported rotatably.

Note that the bottom face of the supporting recessed portion 11g is at a position that is shallower than the bottom face of the supporting recessed portion 11f.

Through this, given the blade driving device 2 of the other example, in the same manner as with the blade driving device 1 of the previous example, while enabling the achievement of a thin, compact structure, the first magnet 40′ and second magnet 50′ are formed in a solid shape, increasing the volumes thereof, thus enabling an increase in the driving force on the first blade 20 and the second blade 30, and, in particular, making it possible to produce an adequate holding force when the first blade 20 and second blade 30 are held in the closed position or open position.

Note that, as yet another example, the first magnet 40′ and second magnet 50′ may be provided with through holes for adjusting, for example, the driving force, magnetic force, or the like, and may also be provided with holes for positioning. That is, as another example, the first magnet 40 and the second magnet 50 may be of shapes other than the solid circular column shape that is illustrated.

### <Image-Capturing Equipment, or the Like>

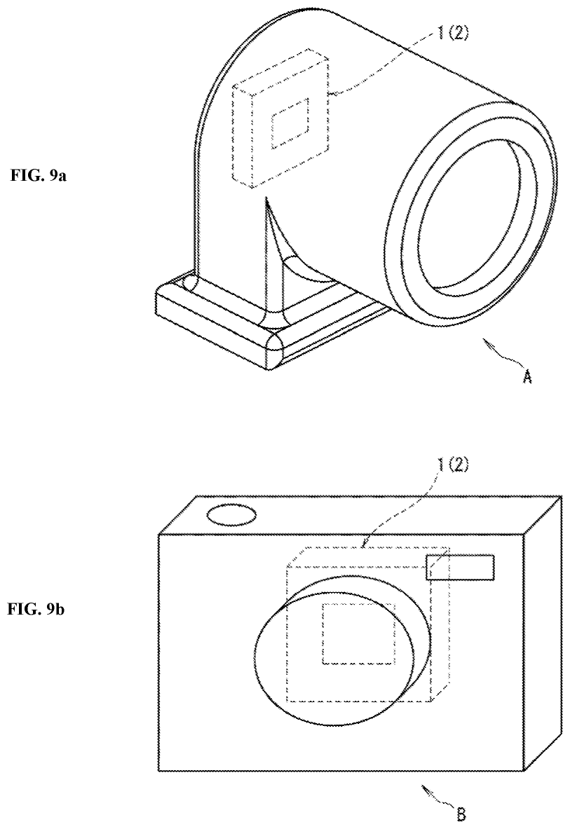

The blade driving devices 1 and 2, described above, structure image-capturing equipment A and B, as depicted in FIG. 9a and FIG. 9b.

Image-capturing equipment A is an example of an infrared radiation camera (a night vision camera), equipped with a blade driving device 1 or 2, a lens that is positioned to the front of the blade driving device 1 or 2, a photodetecting element, a processing circuit for processing an image signal that is captured by the photodetecting element, a memory, and the like, within a casing.

Image-capturing equipment B is an example of a digital camera, equipped with a blade driving device 1 or 2, a lens that is positioned to the front of the blade driving device 1 or 2, a photodetecting element, a processing circuit for processing an image signal that is captured by the photodetecting element, a memory, and the like, within a casing.

The image-capturing equipment A and B have relatively small structures, with good ease of operation as well, through the structure, described above, for the blade driving device 1 or 2.

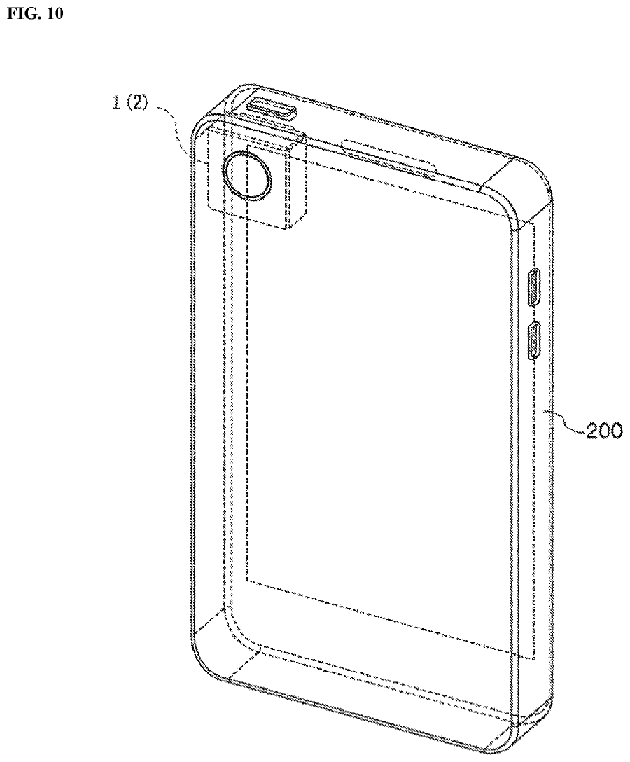

Moreover, the blade driving device 1 or 2 can be applied not only to these image-capturing equipment A and B, but also to the mobile device 200 depicted in FIG. 10, and to vehicle-mounted devices, and the like, as well.

Moreover, while in the example that is illustrated the blade driving device 1.2 was assembled into the camera module in such a way that the side to which the supporting piece 12 protrudes will be on the imaging subject side, in another embodiment it may be assembled into a camera module in such a way that the side to which the supporting piece 12 protrudes is on the sensor side instead, that is, the opposite of the form described above.

Moreover, in the example set forth above, while two blades were provided over the base plate, as another example a form is possible wherein a single blade is provided, or three or more blades are provided.

Moreover, as a yet further example, in the plan view the first magnet 40 and the second magnet 50 may each be polygons, for example, hexagons, or the like, instead of circles.

Moreover, the first magnet 40 (or 40′), second magnet 50 (or 50′), yoke 60, and coil 70, described above, structure an actuator, where this actuator may be used for rotational driving of a member other than the blade described above.

While examples according to the present invention were described in detail above, the specific structures thereof are not limited to these embodiments, but rather design variations within a range that does not deviate from the spirit and intent of the present invention are also included in the present invention. Moreover, insofar as there are no particular contradictions or problems in purposes or structures, or the like, the technologies of the various embodiments described above may be used together in combination.

1. A blade driving device, comprising:
a base plate, comprising an opening for an optical path;
a blade opening and closing an opening, through rotating along a blade supporting face that is present over the base plate;
a magnet that is secured around a rotational center of the blade;
a yoke that is secured to the base plate; and
a coil that is wrapped on yoke,
wherein the yoke comprises:
an adjacent piece that is adjacent to the magnet, along the blade supporting face, and
a cross piece along a side face portion of the base plate, extending in a direction that is perpendicular to the adjacent piece; and
wherein the coil is disposed on the cross piece side.

2. The blade driving device as set forth in claim 1, wherein:
the blade comprises:
a first blade, and
a second blade that rotates at a position that is different from that of the first blade;
the magnet comprises:
a first magnet that is secured to the first blade, and
a second magnet that is secured to the second blade; and
the yoke comprises:
a first adjacent piece that is adjacent to the first magnet, and
a second adjacent piece that is adjacent to the second magnet, wherein these two adjacent pieces are combined together through the cross piece.

3. The blade driving device as set forth in claim 2, wherein:
the coil is wound on the cross piece so that the first adjacent piece has one polarity and the second adjacent piece has the opposite polarity.

4. The blade driving device as set forth in claim 1, further comprising:
a supporting recessed portion of a round cylindrical shape is provided on the base plate at a position corresponding to the rotational center portion of the blade; and
wherein the magnet is formed in a solid circular column shape with one half portion and the other half portion, in the radial direction, being of opposite polarities, where, in this magnet, the blade is secured to one end side, in the axial direction, and the other end side is fitted into the supporting recessed portion and supported so as to enable rotation.

5. An image-capturing equipment comprising a blade driving device as set forth in claim 1.

6. An actuator comprising:
a magnet that is supported rotatably,
a yoke, and
a coil that is wound on the yoke, wherein:
the yoke comprises:
an adjacent piece that is adjacent to the magnet, from the outside in the radial direction, and
a cross piece that is provided extending in a direction that crosses the adjacent piece,
the coil is disposed on the cross piece side.
